(19) United States
(12) Patent Application Publication
(10) Pub. No.: US 2003/0127951 A1
(43) Pub. Date: Jul. 10, 2003

(54) Hermetic mail handler

(76) Inventor: Jose G. Garcia, McAllen, TX (US)

Correspondence Address: Soules & Wallace, Attn: Janice Leverett, Frost Bank Tower, 100 W. Houston St., Suite 1500, San Antonio, TX, 78205, US

(21) Appl. No.: 10/042,921

(22) Filed: Jan. 9, 2002

(51) Int. Cl. B25J 21/02

(52) U.S. Cl. 312/1

(57) ABSTRACT

A hermetic mail handler comprising a container frame, a door and a plurality of walls having at least a pair of gloves recessed in a wall in which a user inserts his/her hands therein in order to manipulate mail. Further, a material handling system carrying envelopes, packages and the like is capable of running into and through the hermetic mail handler. An emergency button and an emergency precautions list is mounted onto the mail handler thereby halting the mail manipulation process and providing instructions for such situation.

In an alternative embodiment, the hermetic mail handler comprises a cavity housed by a plurality of interconnecting walls being fastened to one another and a door. The walls are adapted to move from an open to a closed position and may also be removed from one another. Two opposing walls are capable of being removed thereby allowing a material handling system to pass through a cavity.

### TECHNICAL FIELD

The present invention relates to a mail handling system; more particularly, to a hermetic mail handler designed to aid a user in manipulating and opening mail, such as envelopes, packages and the like in a sealed environment.

### BACKGROUND OF THE INVENTION

Since Sep. 11, 2001, the United States and undisclosed territories have been under the threat of Anthrax scares and some mail recipients' have had physical contact contamination from mail, packages or the like being disseminated through the Post Office system. As a result, many mail recipients have resorted to either not opening mail items, returning the mail back to the original sender, immediately discarding mail without examining the mail item's contents or using surgical gloves during the process of opening the mail.

Glove box isolation chambers are known in the art whereby in order to keep the chamber free from contaminants, a person or operator handling and manipulating the samples is isolated from the chamber and the manipulations are carried out by means of a sleeve affixed to openings in a wall of the chamber. An example of such a glove box is depicted in U.S. Pat. No. 4,141,609 (“'609 patent”) issued to Eisert in 1979. The '609 patent provides for a system for affecting access into sealed enclosures incorporating an arm-length sleeve, one end of which is sealed in a port fitting in the wall of the chamber and the other end of which is fitted with a replaceable glove. However, the '609 patent only provided for a sleeve thereby making a manipulation inside the glove box difficult to achieve.

However, as technology advanced, many improvements were made to the glove box. An example of such improvement is seen in U.S. Pat. No. 5,170,027 (“'027 patent”) issued to Brodersen in 1992. The '027 patent described an inert gas working environment glove box having a housing defining a work chamber and a stovepipe section. Flexible glove sections are connected to the housing and are inserted into the work chamber. Further, a valve is connected to the stovepipe section for exiting gas from the work chamber and stovepipe section. However, the '027 patent does not provide for a container having a plurality of walls capable of being removed or retracted. Further, it does not allow for a device to be inserted into and through the work environment.

In 1999, another glove box was introduced to the market as depicted in U.S. Pat. No. 5,890,781 (“'781 patent”) issued to Ryder. Here, the glove box includes a rigid frame having a first hollow face defining a drum receiving portion and a second face defining an outlet. Four remaining faces of the frame are open and a flexible glove bag is shaped to fit over the frame covering the open faces and to be sealingly attached to the frame. Nevertheless, the '781 patent fails to provide for a device to run into and through the glove box.

In view of the above deficiencies associated with the use of glove box devices, the present invention has been developed to alleviate these drawbacks and provide further benefits to the user as well as society as a whole. These enhancements and benefits are described in greater detail herein below with respect to several alternative embodiments of the present invention.

### SUMMARY OF THE INVENTION

The present invention in its several disclosed embodiments alleviates the drawbacks described above with respect to gloves box devices and incorporates several additionally beneficial features. The present invention is a hermetic mail handler incorporating a container frame having a cavity positioned inside a plurality of walls and a door. Each wall is preferably adapted to disconnect from one another or is capable of extending into an open configuration and retracting into a closed position. At least one of the walls has at least a pair of apertures capable of receiving one or more pair of gloves extending into the cavity.

In an alternative embodiment, a material handling system extends into and through the cavity. Mail items are fed into or placed on the mail handler; and if one or more mail items contain contaminants therein, an emergency button attached to the mail handler may be pressed thereby stopping the material handling system. Further, an emergency precautions list is adhered onto the mail handler displaying an instructional procedure to the user.

It is therefore a goal of the present invention to impart a sense of safety to a user's life and health by providing a hermetic mail handler that allows the user to manipulate, and through transparent materials, view possible contaminants inside mail items without being in direct contact. Specifically, the hermetic mail handler, being made of durable material, isolates and protects a user from any harmful substances or bombs inserted into a mail item. Further, the present invention is capable of accepting various mail items ranging in size such as from an envelope to a package; and may be for utilized for commercial or residential uses and is easy to manufacture.

Another advantage of the present invention is to provide for a hermetic mail handler having removable and/or retractable walls adapted to undergo multiple configurations being customized for a particular user's needs. Single or simultaneous multiple users may engage the present invention based on the amount of gloves mounted thereon. The gloves are preferably antibacterial thereby destroying germs carried by a user and preventing further contamination.

A further advantage of the present invention is to provide for a material handling system promoting efficiency, reducing medical injuries and further allowing mail items to be inspected and pass through a postal system without direct contact. In the event a bomb or foreign substance is detected within a mail item., an emergency button connected to the present invention is depressed and the material handling system is terminated. An emergency precautions list being adhered to the present invention conveys emergency instructions to the user.

Further advantages of the invention will be more clearly understood from the following description of illustrative embodiments thereof, to be read by way of example and not of limitation in conjunction with the apparatus and method shown schematically in the accompanying drawing.

### BRIEF DESCRIPTION OF THE DRAWINGS:

The invention will now be described in greater detail in the following way of example only and with reference to the attached drawings, in which:

FIG. 1 is a perspective view of a hermetic mail handler.

FIG. 2 is an isometric view of an alternative embodiment of the present invention incorporating a conveyor running into and through an enclosed container.

### MODE(S) FOR CARRYING OUT THE INVENTION:

As required, detailed embodiments of the present invention are disclosed herein; however, it is to be understood that the disclosed embodiments are merely exemplary of the invention that may be embodied in various and alternative forms. The figures are not necessarily to scale, some features may be exaggerated or minimized to show details of particular components. Therefore, specific structural and functional details disclosed herein are not to be interpreted as limiting, but merely as a basis for the claims and as a representative basis for teaching one skilled in the art to variously employ the present invention.

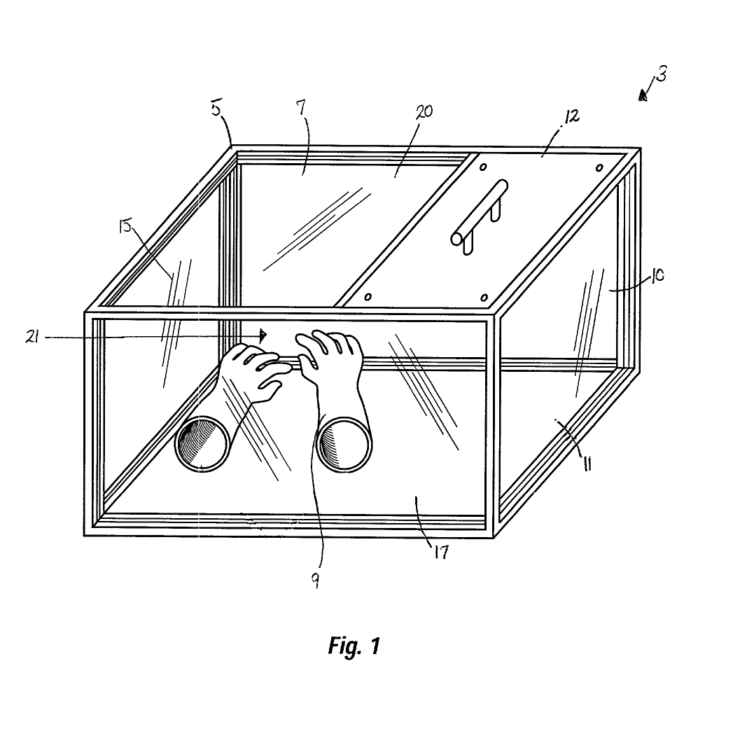

FIG. 1 depicts a hermetic mail handler 3 collectively including a container frame 5 having a cavity 21 interiorly positioned and defined by a top wall 7, a bottom wall 11, side walls 10, 15, 17, 20 and a door 12. Each wall is preferably made of, but not limited to, transparent plastic material allowing a user to view a mail item from within the cavity 21. Alternatively, each wall may be made from fiberglass or other durable or bomb-resistant material.

Each wall may be connected to one another by fasteners such as hinges or welding; or in a preferred embodiment, may be slid into a track system of the frame 5 or mounted onto the container frame 5 made of, but not limited to, stainless steel. Further, each wall is capable of being disconnected from the container frame 5 by either sliding each wall out of the frame track system or by being dismounted from the frame 5 itself.

In the second configuration where the walls are fastened to each other, each wall may be disassembled from one another by removing hinges or other fasteners positioned therebetween.

Further, these hinged interconnecting walls are capable of extending into an open configuration where one end of a wall is pulled upwards and away from other adjacently surrounding walls and also retracting into a closed position.

The cavity 21 ranges in length, width and volume capable of accepting a variety of mail items ranging in size and thickness such as envelopes, packages and any other postal items. The door 12 is bordered by at least two of the remaining walls 10, 20 and is either hingedly fastened to one of the walls 7 or is set on a threshold frame allowing items to be inserted into the cavity 21. Preferably, the door 12 is distally opposed to the bottom wall 11; or alternatively, may be opposingly positioned to one of the side walls. In a preferred embodiment, the periphery of the door 12 incorporates a weatherproofed strip thereby creating an impervious seal when the door 12 is in a closed configuration with respect to the container 5.

At least one of the walls, preferably a side wall, has at least a pair of apertures bored therethrough capable of receiving at least a pair of antibacterial gloves 9, preferably made from latex or Lycra™ spandex. Each glove 9 extends into the cavity 21 thereby allowing the user to manipulate the item placed therein. In a preferred embodiment, multiple pairs of gloves 9 are linearly mounted onto the side wall 17 providing for simultaneous multiple users. In the most preferred embodiment, multiple pairs of gloves 9 are attached to a pair of opposing side walls. A seal may extend around the circumference of each aperture in order to reinforce the aperture and prevent contamination to the interior cavity 21.

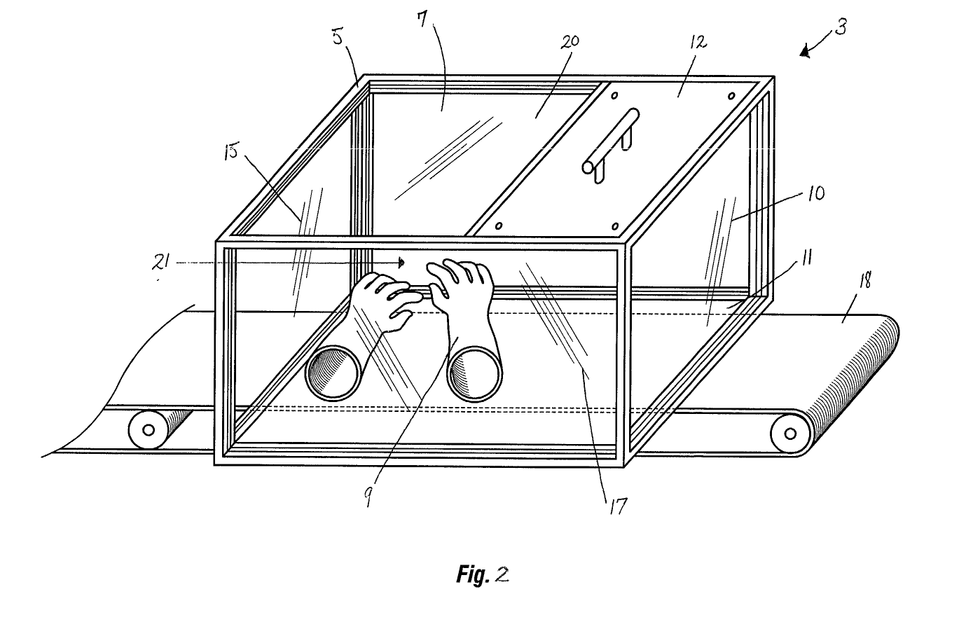

In an alternative embodiment as shown in FIG. 2, two opposing side walls are removed from the mail handler 3 thereby allowing a material handling system 18, namely a conveyor belt system or a track preferably used for a destination-coded vehicle, to perpendicularly extend into and through the cavity 21 of the mail handler 3. Here, the mail handler 3 may extend the entire length of the material handling system 18 or preferably allow each end of the material handling system 18 to protrude outwardly. Mail items are desirably placed directly upon the material handling system 18 which are fed into the mail handler 3; or items may be placed onto the material handling system 18 by way of the door 12. In the event a mail item contains questionable substances or contaminants therein, an emergency button mounted onto the mail handler 3 is depressed halting the material handling system 18. An emergency precautions list being adhered onto the mail handler 3 displays a procedure instructing the user on what actions to take.

### INDUSTRIAL APPLICABILITY

The present invention finds specific industrial applicability in the post office and related mailing distribution industries.

What is claimed and desired to be secured by Letters Patent is as follows:

1. An apparatus for handling mail comprising:
a container frame having a cavity interiorly positioned within a plurality of interconnecting walls and at least one door mounted thereon and being hingedly fastened to at least one of said walls;
at least one of said walls having at least a pair of apertures bored therethrough and being sealingly engaged to at least a pair of gloves; and
a material handling system extending into and through said cavity.

2. The apparatus for handling mail as recited in claim 1, wherein said door has a handle attached thereto.

3. The apparatus for handling mail as recited in claim 1, further comprising an emergency precautions list adhered to one of said walls.

4. The apparatus for handling mail as recited in claim 1, wherein said material handling system is a conveyor belt system.

5. The apparatus for handling mail as recited in claim 1, wherein said container frame is made of material consisting of stainless steel, fiberglass or plastic.

6. The apparatus for handling mail as recited in claim 1, wherein said plurality of walls is made from a material consisting of fiberglass or plastic material.

7. The apparatus for handling mail as recited in claim 5, wherein said material is transparent.

8. The apparatus for handling mail as recited in claim 6, wherein said material is transparent.

9. The apparatus for handling mail as recited in claim 1, wherein said interconnecting walls are capable of being removed from said container frame.

10. The apparatus for handling mail as recited in claim 1, wherein said interconnecting walls are capable of extending and refracting from said container frame.

11. The apparatus for handling mail as recited in claim 1, wherein said material handling system is a destination-coded vehicle system.

12. The apparatus for handling mail as recited in claim 1, wherein said container frame is made of bomb-resistant material.

13. The apparatus for handling mail as recited in claim 1, further comprising an emergency button mounted on and being in electrical communication with said apparatus.

14. The apparatus for handling mail as recited in claim 1, further comprising a threshold frame peripherally surrounding said door.

15. The apparatus for handling mail as recited in claim 1, further comprising a weatherproof strip bordering said door thereby creating a seal.

16. The apparatus for handling mail as recited in claim 1, further comprising multiple pairs of glove linearly fastened onto one of said walls.

17. The apparatus for handling mail as recited in claim 1, wherein said gloves are made from a material consisting of Lycra spandex, latex or antibacterial film.

18. An apparatus for handling mail comprising:
a plurality of interconnecting walls fastened one to another having a cavity interiorly positioned therein and at least one door mounted thereon and being fastened to at least one of said walls; and
at least one of said walls having at least a pair of apertures bored therethrough and being sealingly engaged to at least a pair of gloves.

19. The apparatus for handling mail as recited in claim 18, wherein said interconnecting walls are adjustable to extend into an open configuration and retract to a closed configuration.

20. The apparatus for handling mail as recited in claim 18, further comprising a material handling system passing into and through said cavity of said apparatus.

21. The apparatus for handling mail as recited in claim 20, wherein said material handling system is a conveyor belt system.

22. The apparatus for handling mail as recited in claim 20, wherein said material handling system is a destination-coded vehicle.

23. The apparatus for handling mail as recited in claim 18, further comprising an emergency button mounted on and being in electrical communication with said apparatus.

24. The apparatus for handling mail as recited in claim 18, further comprising an emergency precautions list adhered onto one of said walls.

25. The apparatus for handling mail as recited in claim 18, wherein said door has a handle attached thereto.

26. The apparatus for handling mail as recited in claim 18, wherein said plurality of walls are made of a material consisting of plastic or fiberglass.

27. The apparatus for handling mail as recited in claim 26, wherein said material is transparent.

28. The apparatus for handling mail as recited in claim 18, further comprising a threshold frame peripherally surrounding said door.

29. The apparatus for handling mail as recited in claim 18, further comprising a weatherproof strip peripherally bordering said door thereby creating a seal.

30. The apparatus for handling mail as recited in claim 18, further comprising multiple pairs of glove linearly fastened onto one of said walls.

31. The apparatus for handling mail as recited in claim 18, wherein said gloves are made from a material consisting of Lycra spandex, latex or antibacterial film.
